(19) United States
(12) Patent Application Publication
(10) Pub. No.: US 2024/0031744 A1
(43) Pub. Date: Jan. 25, 2024

(54) METHOD FOR OPERATING A BINAURAL HEARING AID SYSTEM AND BINAURAL HEARING AID SYSTEM

(71) Applicant: Sivantos Pte. Ltd., Singapore (SG)

(72) Inventor: Benjamin Sackenreuter, Erlangen (DE)

(21) Appl. No.: 18/356,496

(22) Filed: Jul. 21, 2023

(30) Foreign Application Priority Data
Jul. 21, 2022 (DE) 10 2022 207 499.8

(51) Int. Cl. H04R 25/00

(52) U.S. Cl. CPC H04R 25/40; H04R 25/554; H04R 25/552; H04R 2460/07

(57) ABSTRACT

A method for operating a binaural hearing aid system includes receiving an acoustic audio signal originating from an acoustic audio source and receiving an electronic audio signal streamed from an electronic audio source and based on the acoustic audio signal of the acoustic audio source. At least in an acoustic operating mode, the acoustic audio signal and the electronic audio signal are jointly processed and an output signal having a directional effect is generated from the two audio signals. The location of the acoustic audio source is located and the directional effect is generated on the basis of the acoustic audio signal. A good spatial hearing perception is thus generated. A hearing aid system for carrying out the method is also provided.

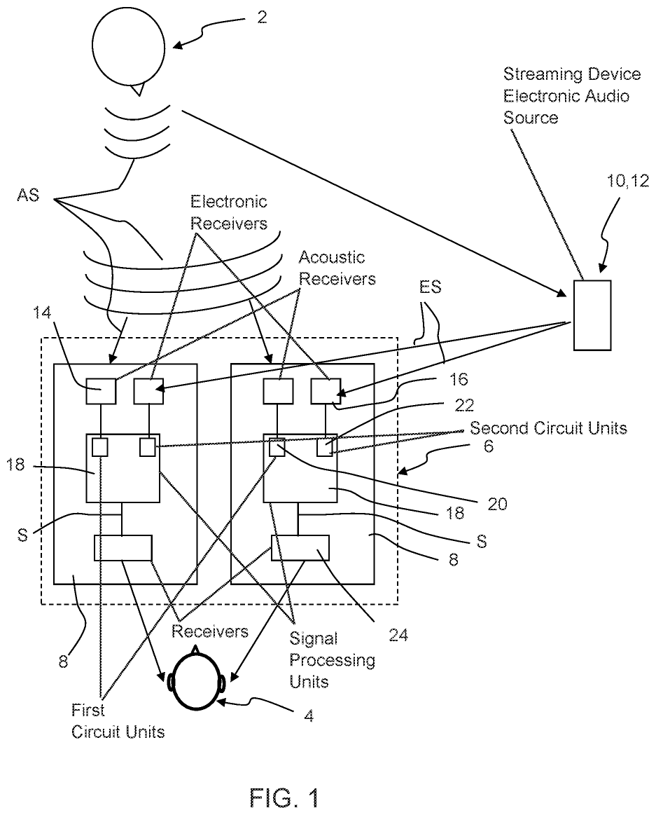

### CROSS-REFERENCE TO RELATED APPLICATION

This application claims the priority, under 35 U.S.C. § 119, of German Patent Application DE 10 2022 207 499.8, filed Jul. 21, 2022; the prior application is herewith incorporated by reference in its entirety.

### FIELD AND BACKGROUND OF THE INVENTION

The invention relates to a method for operating a binaural hearing aid system and such a binaural hearing aid system.

Binaural hearing aid systems generally include two hearing aids, which are worn on the left ear and on the right ear during use by a hearing aid wearer and which exchange information with one another.

Hearing aids are understood in the present case in particular as hearing aid devices, which are configured in a user-specific manner to compensate for an individual, user-specific hearing deficit. Hearing aids and in particular also hearing aid devices each fundamentally include a receiver for an audio signal, a signal processing unit for processing the received audio signal and for outputting a prepared electronic output signal, and a receiver, through which the output signal is emitted to the hearing aid wearer. The emitted output signal is typically an acoustic output signal. The receiver is typically an electroacoustic transducer (loudspeaker), which converts the electronic output signal of the signal processing unit into an acoustic output signal and emits it to the hearing aid wearer.

Binaural hearing aid systems are also used in particular to generate a three-dimensional effect for the hearing aid wearer, wherein the output signal contains a directional effect for directed hearing for that purpose. In that way, the most real possible hearing situation is represented to the hearing aid wearer, so that he or she perceives an audio source in a location-resolved manner, for example. That means that the output signal is prepared in such a way that a hearing perception is generated in the hearing aid wearer in which the audio source is placed in a specific spatial direction.

The generation of the directional effect for directed hearing is fundamentally known. Different technologies can be used for that purpose. For example, time delays and/or level differences are introduced between the output signal emitted to the hearing aid wearer at the left ear and the output signal at the right ear. Additionally or alternatively, the phase relations of the two emitted output signals are also changed. Furthermore, the electronic audio signals can be transformed by using an approximated head-related transfer function (HRTF).

In order to generate the directional effect, initially the received audio signals are analyzed by the signal processing unit with regard to the location of the audio source, so that the location of the audio source is identified on the basis of the received audio signals. Based on that information, the electronic output signal having the directional effect is then emitted at the receiver.

The location information is generally determined on the basis of received acoustic audio signals, for example, on the basis of time delays between two audio signals received at the left and at the right hearing aid.

A hearing aid system is disclosed in European Patent Application EP 2 819 437 A1, which is configured for receiving streamed electronic audio signals. The electronic audio source is located on the basis of those electronic audio signals and an output signal having a directional effect is generated based on the received electronic audio signal.

### SUMMARY OF THE INVENTION

It is accordingly an object of the invention to provide a method for operating a binaural hearing aid system and a binaural hearing aid system, which overcome the hereinafore-mentioned disadvantages of the heretofore-known methods and systems of this general type and which enable improved hearing perception for a hearing aid wearer in a binaural hearing aid system.

With the foregoing and other objects in view there is provided, in accordance with the invention, a method for operating a binaural hearing aid system, which comprises:
receiving an acoustic audio signal which originates from an acoustic audio source,
receiving an electronic audio signal streamed by an electronic audio source, which is based on the acoustic audio signal of the acoustic audio source, and
at least in an acoustic operating mode:
   the acoustic audio signal and the electronic audio signal are jointly processed and a correlated output signal having a directional effect for directed hearing is generated from the two audio signals and is emitted at a receiver, and
   the location of the audio source is located and the directional effect is generated on the basis of the acoustic audio signals.

With the objects of the invention in view, there is also provided a binaural hearing aid system, in particular for carrying out the method, comprising two hearing aids, each respective hearing aid including:
an acoustic receiver, in particular a microphone, for receiving an acoustic audio signal,
an electronic receiver for an electronic streamed audio signal, and
a signal processing unit having at least one processor for processing the acoustic and the electronic audio signal, the signal processing unit being configured, at least in an acoustic operating mode, for the purpose:
   of generating an output signal having a directional effect on the basis of the two audio signals, and
   of locating the location of the audio source and generating the directional effect on the basis of the acoustic audio signals.

A receiver, which normally converts the electronic output signal received from the signal processing unit into an acoustic output signal, is typically provided to output the output signal having the directional effect.

Such a hearing aid system improves the hearing sensation in specific hearing situations, in which an acoustic audio source is present and at the same time the acoustic audio signal of this acoustic audio source is converted into an electronic audio signal and made available via a transmitter as a streamed electronic audio signal. Such hearing situations regularly occur when audio signals are typically intended to be made available for a larger audience, in order to enable the best possible hearing perception for both hearing aid wearers and also non-hearing aid wearers.

Such situations occur, for example, in a lecture hall, concert hall, museum, etc., in which corresponding technical devices for emitting a streamed audio signal are present.

One important aspect of the invention can be seen in that at least in one operating mode, which is designated in the present case as an acoustic operating mode, a correlated output signal is generated from the two received audio signals. A correlated output signal is generally understood in the present case to mean that both information from the acoustic audio signal and information from the electronic audio signal is processed and used to generate the output signal having the directional effect.

Furthermore, it is important that in the selected acoustic operating mode, the information about the location of the acoustic audio source is extracted from the acoustic audio signal and this directional information is used to generate the directional effect in the output signal for the directed hearing.

This configuration is based on the consideration that in the above-described hearing situations, the problem frequently exists that the acoustic audio source and the electronic audio source are separated, i.e., are placed at different locations. If the location of the electronic audio source were used for the directional effect in such a case, an incorrect hearing perception would thus be generated in the hearing aid user. At the same time, the acoustic audio signal is often overlaid with a large number of interference noises, so that signal processing solely on the basis of the acoustic audio signal would result in a lower quality output signal.

By way of the embodiment especially described herein having the correlated output signal, therefore, on the one hand, a good tone quality is provided on the basis of the electronic audio signal, and at the same time the location of the audio source is determined reliably via the acoustic audio signal and used for the directed hearing.

For the analysis of the received audio signals, a respective hearing aid of the hearing aid system in each case includes a suitable electronic circuit unit, with the aid of which the location of the respective audio source is inferred from the received audio signals in a fundamentally known manner.

For a mutual assignment of the acoustic and the electronic audio signal, a correlation is preferably carried out mathematically: The electronic audio signal is correlated, for example, with all identified acoustic signal sources in the surroundings of the hearing aid wearer.

In order to generate the directional effect, a suitable electronic circuit is furthermore formed in the signal processing unit, with the aid of which the output signals, on the one hand, for the left ear and, on the other hand, for the right ear are prepared having the desired directional effect. The signal processing unit is also generally a complex circuit for signal processing.

The advantages and preferred embodiments set forth hereinafter with regard to the method are also to be transferred accordingly to the hearing aid system and vice versa.

In one preferred embodiment, the acoustic audio signal is only used for determining the location of the audio source and for generating the directional effect. This is understood to mean that the acoustic audio signal is only used to identify the location of the acoustic audio source.

In contrast, amplification and preparation of the acoustic audio signal, in particular to compensate for an individual hearing impairment, preferably does not take place. For this purpose, (only) the electronic audio signal is prepared accordingly, i.e., prepared with the aid of the signal processing unit on the basis of the user-specific individual settings and in particular to compensate for an individual hearing impairment. For this purpose, in particular a frequency-selective amplification is performed in accordance with a previously individually established hearing impairment of the hearing aid wearer. In order to generate the directional effect, the electronic audio signal prepared in this way is prepared in consideration of the location of the audio source previously determined on the basis of the acoustic audio signal using the known measures for the two hearing aids, as were mentioned at the outset, to generate the desired directional effect. The parts of the signal preparation which are used to compensate for the individual hearing impairment in particular take place solely on the basis of the electronic audio signal.

In one preferred refinement, the electronic audio signal is furthermore processed, for example, by one or more of the following measures:

An individual head-related transfer function of the hearing aid wearer is taken into consideration and included.

(Acoustic) properties of the surroundings of the hearing aid wearer are simulated. Thus, for example, room acoustics are included in the processed electronic audio signal. For this purpose, in particular a so-called pulse response of the room in which the acoustic audio source and/or the hearing aid wearer are located is determined and simulated. For the determination of the room acoustics, especially the pulse response, the acoustic audio signal is evaluated. In this case, further information in addition to the location of the acoustic audio source is therefore determined from the acoustic audio signal.

The individual signal preparation on the basis of the individual hearing impairment of the hearing aid wearer, thus the preparation of the audio signal to compensate for the individual hearing impairment, is preferably generally performed solely on the basis of the electronic audio signal.

In one expedient refinement, the location of the respective audio source is determined in each case both on the basis of the acoustic audio signal and on the basis of the electronic audio signal, thus, on the one hand, the location of the acoustic audio source and, on the other hand, the location of the electronic audio source.

In one preferred refinement, it is finally checked whether the locations of the audio sources correspond or are separate. The hearing situation can therefore be analyzed and determined more accurately by the double determination of the location of the audio source, in order to generate the most real possible hearing perception on the basis of this information.

For the case in which it is recognized in this check that the two locations are separate, the acoustic audio signal is used for determining the location of the acoustic audio source and for generating the directional effect. The acoustic audio signal is especially used exclusively. Location information which is contained in the electronic audio signal, in contrast, is not taken into consideration. In this case, the acoustic operating mode is set.

In one preferred embodiment, it is furthermore provided that in the case in which it is recognized in the check that the two locations correspond, the electronic audio signal is used for determining the location of the audio source and for generating the directional effect. Therefore, location information contained in the electronic audio signal is used for generating the directional effect.

According to a first variant, the electronic audio signals are only used as a supplement, so that both the electronic audio signals and the acoustic audio signals are thus used for the determination of the location, by which the most accurate possible location resolution is achieved.

According to a second variant, exclusively the electronic audio signal is used for determining the location and for generating the directional effect. In this case, in which the location determination is performed exclusively on the basis of the electronic audio signal, a different operating mode is therefore set, which is designated hereinafter as the electronic operating mode. In this operating mode, the acoustic audio signal preferably remains completely unconsidered for the signal preparation; it is therefore not used for the signal preparation and the generation of the output signal.

The electronic audio signal is generally a radio signal and preferably a Bluetooth signal. This is provided in particular via a so-called side link connection to the hearing aid system. The electronic audio signal is generated by a transmitter, which is also designated as a streaming device and which represents the electronic audio source.

Other features which are considered as characteristic for the invention are set forth in the appended claims.

Although the invention is illustrated and described herein as embodied in a method for operating a binaural hearing aid system and a binaural hearing aid system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURE

The single FIGURE of the drawing is a block diagram of an exemplary embodiment of the invention, showing a hearing aid situation having a speaker as an acoustic audio source and a hearing aid wearer having a binaural hearing aid system.

### DETAILED DESCRIPTION OF THE INVENTION

Referring now in detail to the single FIGURE of the drawing, there is seen a hearing situation in which a speaker, who represents an acoustic audio source 2, is located, for example, in a room, such as a lecture hall, or outside at a defined location.

Furthermore, a hearing aid wearer 4 is shown, who wears a binaural hearing aid system 6 having two hearing aids 8. The hearing aids 8 are configured, for example, as BTE hearing aids, ITE hearing aids, etc.

An acoustic audio signal AS, which is emitted from the acoustic audio source 2, is received by both hearing aids 8.

Furthermore, a streaming device 10 is provided, which emits an electronic audio signal ES on the basis of the acoustic audio signal AS emitted from the acoustic audio source 2. The streaming device 10 is therefore a transmitter for the electronic audio signal ES and thus at the same time forms an electronic audio source 12. In the illustrated hearing situation, the electronic audio source 12 is at a distance from the acoustic audio source 2.

The two hearing aids 8 are configured to receive the electronic audio signal ES.

The binaural hearing aid system 6 is configured to output an output signal S having directional effect for directed hearing.

A respective hearing aid 8 includes in each case an acoustic receiver 14 for receiving the acoustic audio signal AS and an electronic receiver 16 for receiving the electronic audio signals ES. The acoustic receiver 14 is in particular a microphone. Furthermore, a respective hearing aid 8 includes a signal processing unit 18. A respective receiver 14, 16 transmits a possibly prepared audio signal to the signal processing unit 18. In the case of a microphone, the acoustic audio signal AS is converted into an electronic signal.

The signal processing unit 18 includes a first circuit unit 20 for analyzing the received acoustic audio signal AS and a second circuit unit 22 for analyzing the received electronic audio signal ES. These two circuit units 20, 22 are configured to evaluate the respective audio signals AS, ES with regard to the location of the respective audio source 2, 12.

The signal processing unit 18 is furthermore generally configured to generate a correlated electronic output signal S having a directional effect.

This output signal S is passed on in each case to a receiver 24 of the hearing aid 8, which typically converts the electronic output signal S into an acoustic output signal.

In order to generate the directional effect, the signal processing unit 18 makes use, in a first acoustic operating mode, either solely or additionally of the location information contained in the acoustic audio signal AS. That is to say, the signal processing unit 18 generates the directional effect based on the location information contained in the acoustic audio signal AS about the acoustic audio source 2.

The acoustic audio signal AS is preferably used exclusively for determining the location information. More extensive signal preparation of the acoustic audio signal AS preferably does not take place, at least not in a hearing situation in which the electronic streamed audio signal ES is also available in parallel in addition to the acoustic audio signal AS.

The electronic audio signal ES is prepared in accordance with user-specific individual settings in a manner known per se by the signal processing unit 18. For this purpose, in particular an individual, frequency-dependent amplification of the received electronic audio signal ES is performed.

In order to generate the directional effect, the two output signals for the left hearing aid 8 and the right hearing aid 8 are then prepared on the basis of the location information obtained from the acoustic audio signal AS in a suitable manner known per se so that the directional effect is included.

The hearing aid wearer 4 therefore receives acoustic signals from each of the two hearing aids 8, which signals include the desired directional effect or generate it as a hearing perception in the hearing aid wearer 4.

In one embodiment variant, it is provided, for example, that the signal processing unit 18 determines both the location of the acoustic audio source 2 and the location of the electronic audio source 12 and checks whether the two locations correspond. Different operating modes can be set in dependence on the check. In particular in case of a separation of the two locations, a so-called acoustic operating mode is set in which the location information is obtained solely from the acoustic audio signals.

If the two audio sources 2, 12 correspond in location, a modified acoustic operating mode can be set in which both the acoustic audio signal AS and the electronic audio signal ES are used for the determination of the location of the (acoustic) audio source.

In a further operating mode, which is designated as an electronic operating mode, in contrast, the location information—especially but not necessarily for the case in which the two audio sources 2, 12 correspond—is inferred solely from the electronic audio signal ES. In this operating mode, the acoustic audio signal AS is not used for the signal preparation.

The following is a summary list of reference numerals and the corresponding structure used in the above description of the invention.

### LIST OF REFERENCE SIGNS

2 acoustic audio source
4 hearing aid wearer
6 binaural hearing aid system
8 hearing aid
10 streaming device
12 electronic audio source
14 acoustic receiver
16 electronic receiver
18 signal processing unit
20 first circuit unit
22 second circuit unit
24 receiver
AS acoustic audio signal
ES electronic audio signal
S output signal

1. A method for operating a binaural hearing aid system, the method comprising:
receiving an acoustic audio signal originating from an acoustic audio source;
receiving an electronic audio signal streamed by an electronic audio source, the electronic audio signal being based on the acoustic audio signal of the acoustic audio source; and
at least in an acoustic operating mode:
jointly processing the acoustic audio signal and the electronic audio signal and generating an output signal having a directional effect from the acoustic audio signal and the electronic audio signal; and
identifying a location of the acoustic audio source and generating the directional effect based on the acoustic audio signal.

2. The method according to claim 1, which further comprises only using the acoustic audio signal for determining the location of the acoustic audio source and for generating the directional effect.

3. The method according to claim 1, which further comprises performing a signal preparation, to compensate for an individual hearing impairment of the hearing aid wearer, solely based on the electronic audio signal.

4. The method according to claim 1, which further comprises determining the location of the acoustic audio source and a location of the electronic audio source both on the basis of the acoustic audio signal and on a basis of the electronic audio signal.

5. The method according to claim 4, which further comprises checking whether the locations of the acoustic audio source and the electronic audio source correspond or are separate.

6. The method according to claim 4, which further comprises using the acoustic audio signal for generating the directional effect, when the locations of the acoustic audio source and the electronic audio source are separate.

7. The method according to claim 5, which further comprises using the electronic audio signal at least additionally or alone for generating the directional effect, when the locations of the acoustic audio source and the electronic audio source correspond.

8. The method according to claim 1, which further comprises providing a radio signal as the electronic audio signal.

9. The method according to claim 1, which further comprises providing a Bluetooth signal as the electronic audio signal.

10. A binaural hearing aid system, comprising two hearing aids each including:
an acoustic receiver for receiving an acoustic audio signal;
an electronic receiver for receiving an electronic streamed audio signal; and
a signal processing unit for processing the acoustic audio signal and the electronic audio signal, said signal processing unit being configured for:
generating an output signal having a directional effect based on the acoustic audio signal and the electronic audio signal, and
identifying a location of the acoustic audio source and generating the directional effect based on the acoustic audio signal, at least in an acoustic operating mode.

11. The hearing aid system according to claim 10, wherein said signal processing unit is additionally configured for identifying a location of the electronic audio source based on the electronic audio signal.
